(19) United States
(12) Patent Application Publication
(10) Pub. No.: US 2025/0054011 A1
(43) Pub. Date: Feb. 13, 2025

(54) SYSTEMS AND METHODS FOR INCENTIVIZING SOCIAL INTERACTION IN CONNECTION WITH A DIGITAL PLATFORM

(71) Applicant: Aisle 6 Offerings, LLC, Birmingham, AL (US)

(72) Inventors: Blake Patterson, Birmingham, AL (US); Geran D'Klerk, Cape Town (ZA); Wes Letson, Birmingham, AL (US)

(21) Appl. No.: 18/799,742

(22) Filed: Aug. 9, 2024

Related U.S. Application Data
(60) Provisional application No. 63/532,318, filed on Aug. 11, 2023.

(51) Int. Cl. G06Q 30/0207; G06Q 50/02

(52) U.S. Cl. CPC G06Q 30/0207; G06Q 50/02

(57) ABSTRACT

Systems and methods for incentivizing social interaction are disclosed herein. The system includes a plurality of products. The products can include a first product and a second product, each comprising a physical article and an associated digital asset. The system includes a digital platform. The digital platform can include a user interface configured to permit a user to perceive and interact with the platform; a product selection module configured to permit a user to purchase a product; a performance tracking module configured to track whether an owner of a product has completed a performance activity, such as a social connection between an owner of the first product and an owner of the second product; an incentive module configured to reward an owner for completing the performance activity; and a communications module configured to receive performance activity data from the performance tracking module and send such data to the incentive module.

### CROSS-REFERENCES TO RELATED APPLICATIONS

This application claims priority to and the benefit of U.S. Provisional Patent Application No. 63/532,318, filed Aug. 11, 2023, which is incorporated by reference in its entirety.

All patents, patent applications and publications cited herein are hereby incorporated by reference in their entirety. The disclosures of these publications in their entireties are hereby incorporated by reference into this application to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present disclosure generally relates to wearable goods and a digital platform associated therewith. More specifically, the disclosure includes clothing that is associated with a unique or limited digital identifier. Certain embodiments relate to systems and methods of incentivizing social interaction using the digital identifier associated with one or more clothing items.

### BACKGROUND

The present disclosure generally relates to wearable goods and a digital platform associated therewith, and more particularly to systems and methods for incentivizing social interaction in connection with the digital platform and wearable goods. Products, such as wearable goods, may not be unique, and if they are unique, there is no mechanism for the owners of the unique goods to connect. What is needed is a platform that allows social interaction between owners of wearable goods associated with a unique or limited digital identifier.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a non-transitory computer-readable storage medium having executable instructions stored thereon. The executable instructions, when executed by a processor, may be configured to perform one or more steps. The one or more steps may include receiving first location data from a first user computing device associated with a first owner of a first physical article of a plurality of physical articles. The steps may include receiving second location data from a second user computing device associated with a second owner of a second physical article from the plurality of physical articles. The steps may include determining whether the first location data and the second location data are within a first threshold geographical proximity to one another. The steps may include, in response to the first location data and the second location data being within the first threshold geographical proximity to one another, sending a first notification to the first user computing device and the second user computing device.

Another aspect of the disclosure is a method. The method may include receiving, by a computing device, first location data from a first user computing device associated with a first owner of a first physical article of a plurality of physical articles. The method may include receiving, by the computing device, second location data from a second user computing device associated with a second owner of a second physical article from the plurality of physical articles. The method may include determining, by the computing device, whether the first location data and the second location data are within a first threshold geographical proximity to one another. The method may include, in response to the first location data and the second location data being within the first threshold geographical proximity to one another, sending, by the computing device, a first notification to the first user computing device and the second user computing device.

Another aspect of the disclosure is a system having at least one memory with non-transitory computer-executable instructions stored thereon. The system may include a computing device with at least one processor for executing the non-transitory computer-executable instructions, a first user computing device associated with a first owner of a first physical article of a plurality of physical articles, and a second user computing device associated with a second owner of a second physical article from the plurality of physical articles. The non-transitory computer-executable instructions, when executed by the computing device, may cause the computing device to perform one or more operations. The one or more operations may include receiving first location data from the first user computing device. The operations may include receiving second location data from the second user computing device. The operations may include determining whether the first location data and the second location data are within a first threshold geographical proximity to one another. The operations may include, in response to the first location data and the second location data being within the first threshold geographical proximity to one another, sending a first notification to the first user computing device and the second user computing device.

Another aspect of the disclosure is a system having a plurality of products comprising a first product and a second product, wherein each product comprises a physical article and an associated digital identifier, and a digital platform. The digital platform includes a user interface configured to permit a user of the digital platform to perceive and interact with the digital platform. The digital platform includes a performance tracking module configured to track whether a performance activity has been completed, wherein the performance activity comprises a social connection between a first owner of the first product and a second owner of the second product. The digital platform includes an incentive module configured to reward the first owner and the second owner for completing the performance activity. The digital platform includes a communications module configured to receive performance activity data from the performance tracking module and send the performance activity data to the incentive module.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1A is a block diagram illustrating one embodiment of a system of the present disclosure.

FIG. 1B is a block diagram illustrating one embodiment of a system of the present disclosure.

FIG. 2A is a block diagram illustrating one embodiment of a system of the present disclosure.

FIG. 2B is a block diagram illustrating one embodiment of a system of the present disclosure.

FIG. 3A is a flowchart diagram depicting one embodiment of a method of the present disclosure.

FIG. 3B is a continuation of the flowchart diagram illustrated in FIG. 3A.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

Reference throughout this specification to “one embodiment,” “an embodiment,” “another embodiment,” “optional embodiment” or similar language means that a particular feature, structure, or characteristic described in connection with the embodiment is included in at least one embodiment. Thus, appearances of the phrases “in one embodiment,” “in an embodiment,” “in some embodiments,” “in certain embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

As used herein, the term “computing device” or “computer” may include a desktop computer, a laptop computer, a tablet computer, a mobile device such as a mobile phone or a smart phone, a smartwatch, a gaming console, an application server, a database server, or any other device for computing known in the art. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform,” “digital platform,” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The computing platform may include one or more data storages. The computing platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database, or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing,” and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described such software application able to both send and receive pertinent performance data.

As used herein, the terms “modify” or “modifying” may include several actions. For example, modifying data may include adding additional data or changing the already-existing data. As used herein, the terms “obtain” or “obtaining” may also include several types of action. For example, obtaining data may include receiving data, generating data, designating data as a logical object, or other actions.

As used herein, and unless the context dictates otherwise, the word “product” can refer to a given physical article, the digital identifier associated with the given physical article, or both of the given physical article and the digital identifier associated with the given physical article.

As used herein, the phrase “associated physical article” refers to a given physical article that is associated with a given digital identifier. Similarly, the phrase “associated digital identifier” refers to a given digital identifier that is associated with a given physical article. In embodiments, the physical article and the associated digital identifier are transferred together as a single product during the first sale of the same. Similarly, the digital identifier and the associated physical article can be transferred together as a single product during the first sale of the same.

As used herein, the phrase “plurality of products” refers to a limited number of products that comprise a unique physical or digital attribute which connects or links the products together. In embodiments, a plurality of products can be any number of products that were created, co-released, or sold, wherein each product has an attribute, function, or quality that links the a given product to every other product within the plurality of products. The plurality of products can include up to 100 products. In embodiments, the plurality of products includes up to 50 products. The plurality of products can include up to 25 products. In embodiments, the plurality of products includes up to 10 products. The plurality of products can contain up to 5 products. In one embodiment, the plurality of products includes 2 products. In embodiments, each product within a plurality of products can be numbered with a unique digital identifier, wherein the lowest number is the number “1,” and highest number is “n,” wherein “n” is the total number of products within the given plurality of products. For instance, in embodiments with 10 total products in the plurality of products, each product will be uniquely numbered, with the lowest number being “1” and the highest number being 10. In one embodiment, the color or other design element can be consistent across every product within a given plurality of products. Embodiments can comprise a “line of products” that is made up of one or more pluralities of products. By way of non-limiting example, a “line of products” can comprise a hoodie with a given design, wherein a first plurality of products comprises a first color and a second plurality of products comprises a second color. In embodiments, the number of products within the first plurality of products is less than the number of products in the second plurality of products from the same line of products. In such embodiments, the first plurality of products can be a first color and the second plurality of products can be a second color. Thus, under such embodiments, the color of each product can immediately convey whether the product belongs to the first plurality of products or the second plurality of products from the same line.

As used herein, the phrase “parallel products” refers to at least two products within a given plurality of products. Each of the parallel products can be substantially similar to one another. In one embodiment, the parallel products are substantially identical. The parallel products can comprise one or more design elements that are complementary to one another. In embodiments, each parallel product is produced, manufactured, or designed by the same entity and released for purchase at substantially the same time.

One aspect of the disclosure is a system for incentivizing social interactions. The system can include a digital platform and physical products that are each associated with a digital identifier. Another aspect of the disclosure includes a method of incentivizing social interactions, wherein the method employs any of the various systems (e.g., the digital platform) disclosed herein. More specifically, clothing or other physical articles are associated with a unique or limited digital identifier and social interaction among the owners of the physical articles is incentivized using the digital platform and digital identifier.

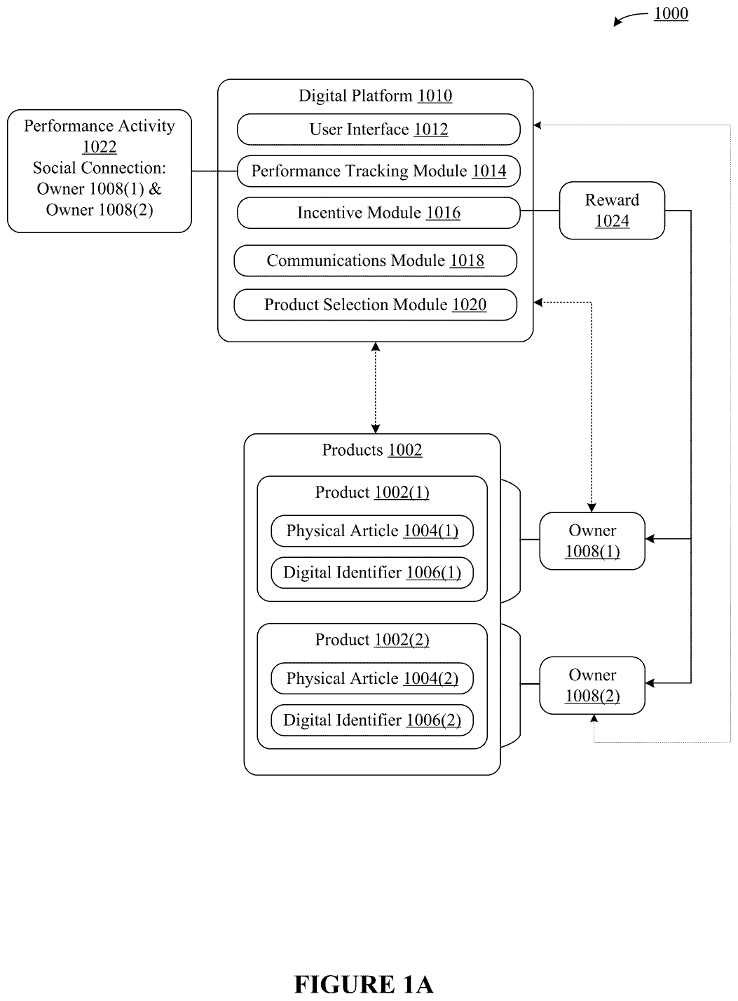

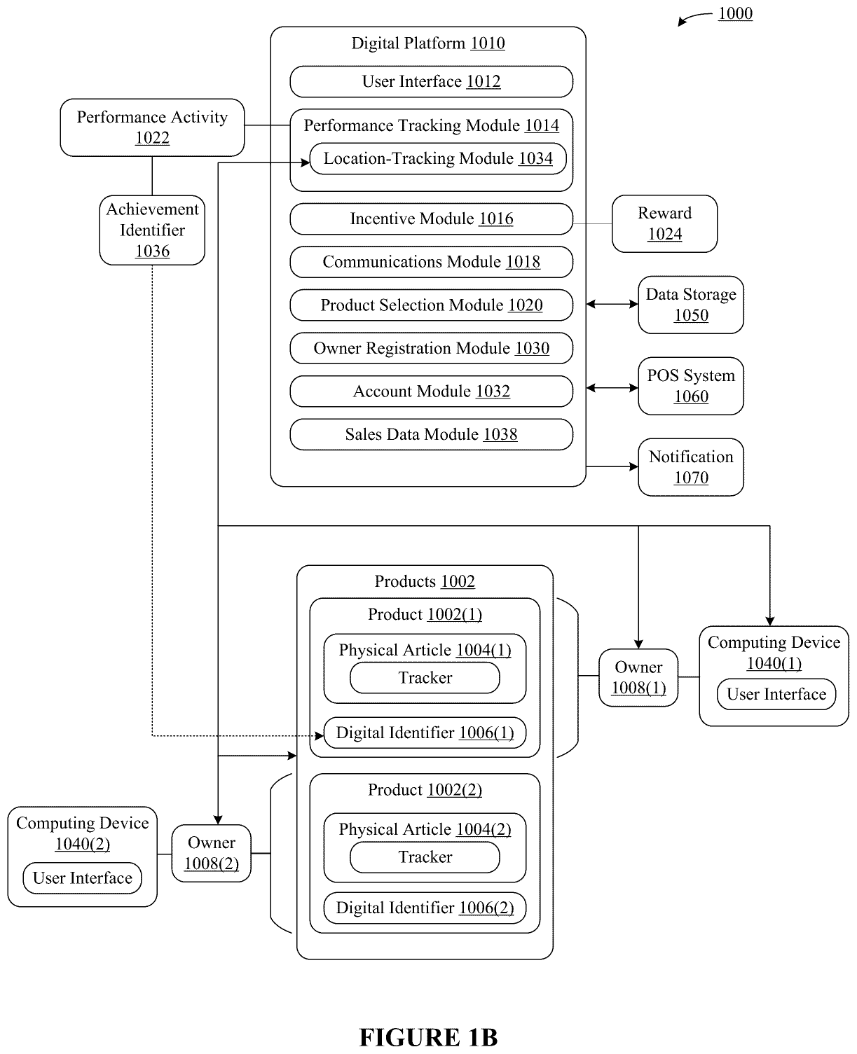

FIG. 1A and FIG. 1B are block diagrams illustrating embodiments of a system 1000 of the present disclosure. The system 1000 can include a digital platform 1010 and a plurality of products 1002. One or more computing devices (not illustrated) can host the digital platform 1010. The products 1002 can include at least two products 1002(1) and 1002(2), although hundreds or thousands of products can be included in the products 1002 of the system 1000. Each of the products 1002 can include a physical article 1004 and a digital identifier 1006 that is associated with the physical article 1004.

The digital platform 1010 may include a user interface 1012, an owner registration module 1030, a product selection module 1020, an account module 1032, a communications module 1018, a performance tracking module 1014, an incentive module 1016, a data storage 1050, or a combination thereof. In embodiments, the performance tracking module 1014 includes a location-tracking module 1034. In certain embodiments, the location-tracking module 1034 is configured to track the location of the physical article 1004, an owner 1008 of the physical article 1004, an owner 1008 of the digital identifier 1006, or a combination thereof. The user interface 1012 is configured to permit a user of the digital platform 1010 to perceive and interact with the digital platform 1010, such as via a user interface of an owner's 1008 computing device 1040. In various exemplary embodiments, the computing device 1040 can include a personal mobile device of a user or an owner 1008. The computing device can include a screen that can display a user interface (UI).

In one embodiment, the systems and methods include providing at least two physical articles from a given plurality of articles to at least two owners, wherein a first physical article 1004(1) is provided to a first owner 1008(1) and a second physical article 1004(2) is provided to a second owner 1008(2). In various embodiments, each of the two physical articles is associated with a digital identifier 1006. In embodiments, both of the physical articles are associated with the same single digital identifier. Alternatively, each of the at least two physical articles comprise a unique digital identifier, wherein the first physical article 1004(1) is associated with a first unique digital identifier 1006(1) and the second physical article 1004(2) is associated with a second unique digital identifier 1006(2). The at least two physical articles can be substantially similar to one another. In one embodiment, the at least two physical articles are substantially identical. The at least two physical articles can comprise one or more design elements that are complementary to one another. In one embodiment, the design element comprises a graphical or patterned design. The design element can be distributed across the at least two physical articles such that, the complete graphical design element is only revealed when the two physical articles are appropriately arranged together.

In one embodiment, the digital identifier 1006 comprises a unique printing on an associated physical article 1004. The digital identifier 1006 can comprise a unique number that is printed on or otherwise associated with the associated physical article 1004. In certain embodiments, the digital identifier 1006 is associated with or comprises data that can only be viewed or interpreted via a computing device. Exemplary visual data (such as a digital image or a digital video), audio data (such as a digital sound), or audio visual data (such as a digital video with sound) that, in each case, when perceived by an individual, is similar to at least one design element of the associated physical article 1004, complementary to at least one design element of the associated physical article 1004, or a combination thereof. The digital identifier 1006 can be associated with a digital image that is substantially identical to at least one design element of the physical article 1004. The digital identifier 1006 can be associated with a digital image or digital sound that comprises a design, pattern, or quality that is similar to the associated physical article 1004, complementary to the associated physical article 1004, or a combination thereof. In embodiments wherein the digital identifier 1006 is associated with a digital video, the digital video can comprise a scene that depicts or discusses at least one design element of the associated physical article 1004. In embodiments wherein the digital identifier 1006 is associated with a digital sound, the digital sound can comprise audio data that, when heard by an individual, mimics a sound made by the physical article 1004, describes the physical article 1004, discusses the physical article 1004, complements the physical article 1004, or any combination thereof.

In embodiments, the digital identifier 1006 comprises a means or mechanism used to distinguish and identify one or more individual and unique objects or a given plurality of objects. The digital identifier 1006 can be distinct for each physical article 1004 or a given plurality of physical articles that is not replicated or used in association with a different physical article or a different plurality of physical articles. The digital identifier 1006 can comprise a number printed on the physical article 1004, an Internet Protocol (IP) address, a Medica Access Control (MAC) address, an electronic serial number, a Universally Unique Identifier (UUID), a Globally Unique Identifier (GUID), a barcode, a radio frequency identification (RFID), a QR code, or any combination thereof. The digital identifier 1006 can be a digital asset, such as a non-fungible token (NFT) which may reside on a blockchain.

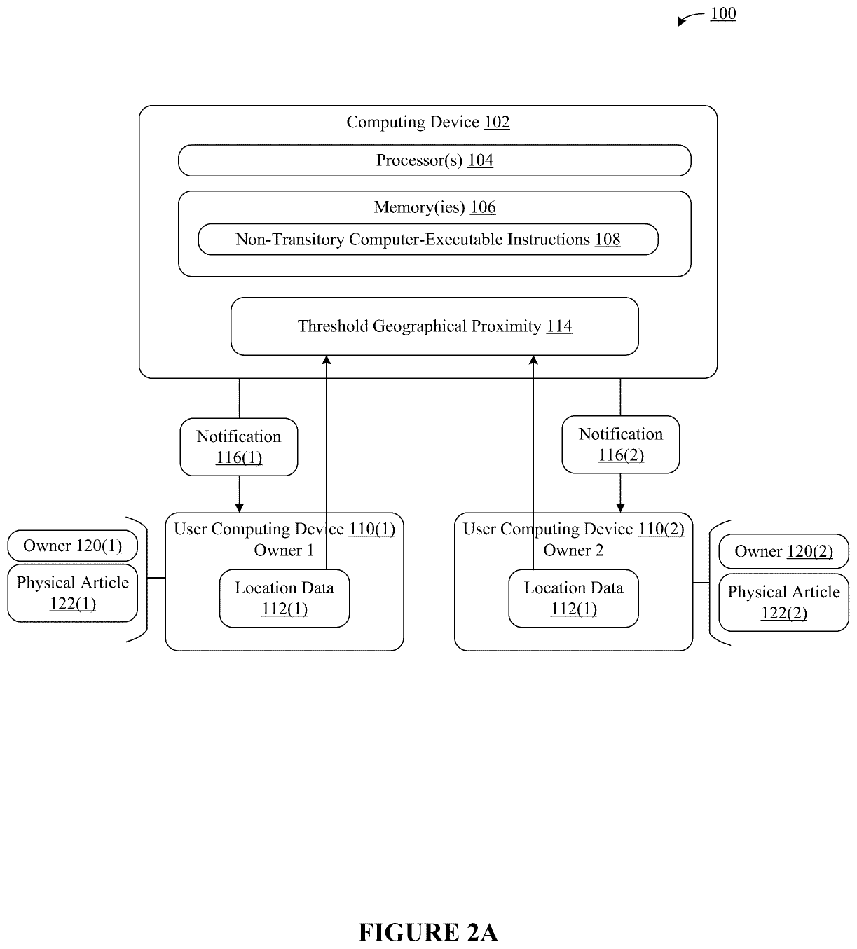

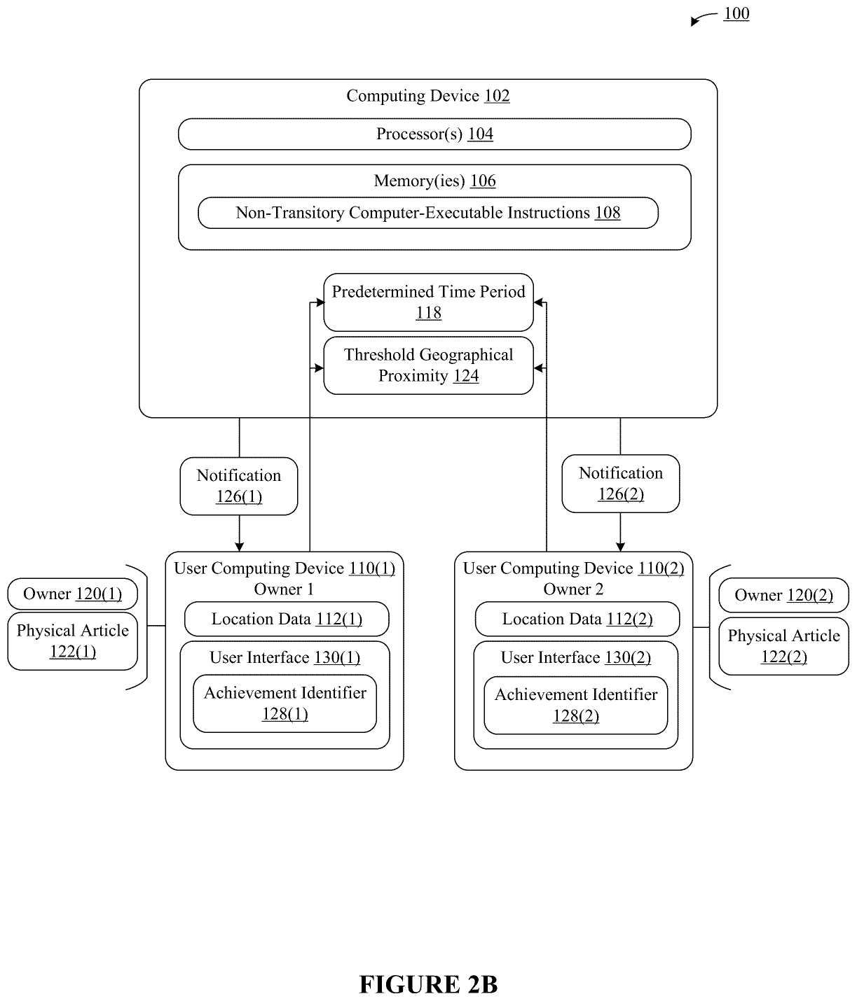

In embodiments wherein the digital identifier 1006 comprises an NFT, the NFT can reside or otherwise operate within or on a digital platform (e.g., the digital platform 1010). In certain embodiments, the digital platform 1010 comprises a decentralized marketplace for exchanging NFTs. The marketplace can operate on a blockchain that permits users to buy, sell, trade, distribute, or collect one or more NFTs. In applicable embodiments, the decentralized nature of the exemplary platform permits users to retain control of their digital asset (i.e., digital identifier 1006) with an absence of a central authority controlling such platform. In certain embodiments, a computing device (e.g., the computing device hosting the digital platform 1010; the computing device 102 illustrated in FIG. 2A and FIG. 2B) can store certain data on a blockchain. For example, certain data can be converted or “minted” into an NFT by publishing a unique instance of the data to a blockchain. Once the data are converted into a digital asset (i.e., digital identifier 1006) stored on a blockchain, they can become salable or transferable. The digital asset may also contain metadata such as the digital asset identification number or information regarding whether a performance activity 1022 or threshold is associated with a given digital asset.

In some embodiments, each of the plurality of physical articles 1004 comprises a means for tracking location data of the physical article. Non-limiting, exemplary means for tracking location data include a satellite-based navigation or tracking system, a system that utilizes a cellular network, a system that utilizes Wi-Fi access points, a system that utilizes Bluetooth®, global positioning system (GPS), a system that employs short-range wireless tracking, or any combination of the foregoing. In specific embodiments, the means for tracking location data comprises radio frequency identification (RFID) tracking, assisted GPS (AGPS), a Wi-Fi positioning system, cell tower triangulation, Bluetooth® tracking, near-filed communication (NFC), a long range wide area network (LoRaWAN), IP geolocation, geofencing, a mobile network location application programming interface (API), or any combination thereof.

In various exemplary embodiments, the physical article 1004 includes, but is not limited to, a physical article that can be worn on a person or pet. The physical article 1004 can be an article of clothing or an accessory that is designed to be worn by the owner 1008 of the physical article 1004. In embodiments, the physical article 1004 comprises a shirt, a jacket, a sweater, a sweatshirt, a hoodie, a pullover, shorts, pants, a skirt, a dress, a hat, a cap, a toboggan, a beanie, one or more shoes, one or more socks, an undergarment, or a combination thereof. In certain embodiments, the physical article 1004 is a portable physical article. Such a portable physical article can include any physical article that is frequently moved from one place to another. The portable physical article can be a physical article that is small enough for an owner to carry the physical article on their person. In embodiments, the portable physical article comprises a bag, a keychain, a watch, a pair of glasses, a pair of sunglasses, a pair of gloves, a pocketknife, a wallet, a portable drink container, or a writing utensil, as non-limiting examples. The physical article 1004 can be a household item, such as bedding or a blanket, as non-limiting examples. In some exemplary embodiments, the physical article 1004 is a collectible item. For example, the physical article can be a trading card, an action figure, a coin, a doll, pop culture memorabilia, or sports memorabilia. The physical article 1004 can be a piece of art, such as a painting, a drawing, a sculpture, a photograph, or pottery, as non-limiting examples.

In certain embodiments, the systems and methods include displaying at least one physical article 1004 via a user interface to one or more potential purchasers of the article, such as via a user interface on computing devices associated with the potential purchasers (e.g., computing device 1040(1) associated with owner 1008(1)). In embodiments, the potential purchaser selects a desired physical article from the physical article selection module (i.e., product selection module 1020) and completes a purchase of the desired physical article. In alternate embodiments, the potential purchaser views the physical article in a physical storefront, purchases the article in the physical storefront, or a combination thereof. After purchasing the physical article 1004, ownership of the physical article 1004 and ownership of the associated digital identifier 1006 is transferred to the potential purchaser, and the potential purchaser becomes the owner 1008 of the physical article 1004 and the owner of the digital identifier 1006 associated with the given physical article 1004. The physical article 1004 can be offered for purchase or exchange by the original creator of the physical article 1004, the original creator of the digital identifier 1006, the digital platform 1010 service provider, or a combination thereof. In embodiments, the physical article 1004 can be offered for purchase or exchange by the owner 1008 of the physical article 1004, the owner 1008 of the digital identifier 1006, or both.

In embodiments, the owner 1008 of the physical article 1004 and the digital identifier 1006 can transfer ownership in the physical article 1004 to a third party. In certain embodiments, the owner of the physical article 1004 and the digital identifier 1006 must be transferred simultaneously to the same third party and vice versa. Alternatively, the physical article 1004 can be transferred to a first third party and the digital identifier 1006 can be transferred to a second third party, wherein the first third party and the second third party are not the same person or entity. As discussed herein, once ownership in the product 1002 (e.g., the physical article 1004) is transferred to a third party, the third party receiving the transfer is identified as the owner 1008 of the product 1002 (e.g., the physical article 1004), as applicable. Such ownership transfers can be recorded via a smart contract as discussed in the present disclosure. One advantage of the systems and methods disclosed herein is that the systems or methods can dynamically or periodically track the transfer of the product from one owner to another. The systems and methods can automatically and simultaneously update the identity of an owner across the digital platform 1010 upon a transfer of ownership of the product 1002. For instance, the systems can comprise data or digital assets stored on the one or more memories of the systems. As discussed herein, each digital asset will be associated with or otherwise paired with a physical article and, at least for the initial sale, both the physical article and the associated digital asset will be transferred as a pair to the same owner. Exemplary digital assets include, but are not limited to, audio data, visual data, audiovisual data, or any other forms of data that can be viewed heard, or otherwise accessed by an owner or user.

In certain embodiments, the systems and methods can dynamically and simultaneously update the market value of a given product, based upon (i) a prior sale of the product, (ii) the scarcity of the product, (iii) whether co-owners of parallel products have successfully connected, or (iv) a combination thereof. In embodiments, the value of a given product increases following an event that indicates that the owners of parallel products have successfully connected. In one embodiment, the owner 1008(1) of the first product 1002(1) may have an opportunity to purchase the second product 1002(2) from the second owner 1008(2) upon successfully connecting with the second owner, or vice versa. In certain embodiments wherein the product comprises a means for tracking location, the means for tracking location can confirm whether the owner of the first product 1002(1) has successfully connected with the owner of the second product 1002(2). Upon confirmation of a successful connection, the digital identifier 1006 can be updated to indicate that such a successful connection has occurred. In embodiments, an achievement identifier 1036 can be associated with the digital identifier 1006 to indicate that a successful social connection was made between at least two owners of products within a given plurality of products 1002.

In embodiments, a target performance threshold or performance activity 1022 can be assigned, and once the target performance threshold or performance activity 1022 is achieved, an achievement identifier 1036 can be added or otherwise associated with the digital identifier 1006, the physical article 1004, or both to indicate completion of the target performance threshold or performance activity 1022. In embodiments, completion of at least one target performance threshold or performance activity 1022 increases the value of the product 1002. In certain embodiments, rolling target performance activities are monitored and updated in a flexible manner that permits updates across the digital platform 1010 that occur simultaneously or near simultaneously with completion of the target performance thresholds or activities. In embodiments, the target performance activity 1022 can be the duration of time between the original transfer of ownership of at least one parallel product and a successful connection between at least two owners of the parallel products. An alternate exemplary target performance activity includes the geographical distance traveled between the at least two owners of the parallel products. In embodiments, the distance traveled to achieve a connection between at least two owners of the parallel products is positively correlated with the achievement identifier 1036, the value of the achievement identifier, or both. In embodiments, at least one target performance activity 1022 can be (i) the greatest distance traveled to achieve a connection between the first owner and the second owner, (ii) the shortest distance traveled to achieve a connection between the first owner and the second owner, (iii) the shortest duration of time between the original transfer of ownership of the parallel products and a successful connection between at least two owners of the parallel products, (iv) the longest duration of time between the original transfer of ownership of the parallel products and a successful connection between at least two owners of the parallel products, (v) the greatest number of distinct connections made between at least two owners of the parallel products over a given period of time, or (vi) any combination thereof. In certain embodiments, the systems and methods disclosed herein calculate a rolling or updated target performance threshold or activity to determine when a given achievement should be transferred or updated to a new owner or plurality of owners.

In certain embodiments, the performance tracking module 1014 is configured to track target performance data for one or more products 1002 and send the target performance data to the incentive module 1016. The performance tracking module 1014 can track whether a performance activity 1022 has been completed. One example of a performance activity 1022 is a social connection between a first owner 1008(1) of the first product 1002(1) and a second owner 1008(2) of the second product 1002(2). The incentive module 1016 may be configured to receive the target performance data from the performance tracking module 1014, dynamically, in real time, or periodically calculate a completion of a given target performance activity 1022 or threshold. In some embodiments, the incentive module 1016 may be configured to automatically administer a positive incentive (e.g., a reward 1024) to an owner 1008 or a user upon completion of a performance activity 1022. For example, when the incentive module 1016 calculates that an owner 1008 or user completed the given target performance activity 1022 or threshold, the incentive module 1016 may send a reward 1024 to the owner 1008 or user for completing the performance activity 1022.

In one embodiment, the target performance activity 1022 includes a statistical performance threshold based on aggregated target performance data from all products 1002, wherein the incentive module 1016 determines, from the target performance data associated with a selected product, whether the target performance threshold has been met and how the target performance data for a given product compares to that of other products. For instance, the performance threshold can be based on a mean, median, mode, percentile, or other statistical metric of the desired performance activity across all products or owners. For example, the incentive module 1016 may calculate a mean time period duration for completing a given performance activity as measured from the initial sale and compare a given product's duration to complete the performance activity to that of other products which are associated with the completed performance activity. In some embodiments, where metrics across regions are desired to be compared, the mean may include the mean sales per product of a group of products over a specific time period, within a specific geographical location, or a combination thereof. The group of products may include the products at a certain physical store (e.g., total sales of a store/the number of products in that store), in a certain city, in a certain region (e.g., county, state, province, country, etc.), that have achieved a given performance activity, a group of products that are selected by a user or administrator of the digital platform, or another grouping of products. Group thresholds can be calculated similarly to the performance activities noted above, and content can be provided to a group of owners or users as needed. The specific time period may include a most recent time period (e.g., the most recent day, week, two weeks, month, quarter, year, etc.), a specified time period (e.g., an interval between two dates), a season (e.g., winter, spring, etc.), or some other time period.

The incentive module 1016 can dynamically calculate a performance threshold based on aggregated data from all products 1002 or a group of products by selecting a predetermined value surrounding the mean as the threshold. The value may include a standard deviation, a percentage (e.g., 10% above the mean), a sales amount, a specific duration, or some other value. In some embodiments, the threshold may be a relative percentile of products or owners, for instance ranking products or owners based on certain data (such as the number of performance activities completed or the duration of time it took to complete a given performance activity) and providing an associated achievement identifier 1036 to the product or owner as applicable.

In some embodiments, the incentive module 1016 can dynamically calculate one or more performance activities 1022 by calculating performance activities on a rolling basis. Performance activities can include a rolling average, other real-time metrics, or other relatively continuous or frequent calculations. Using dynamic statistical performance activities based on aggregated data from all products 1002 or at least one grouping of products over time, as opposed to static predetermined thresholds, can allow for the determination of relative performance activities between different products while accounting for seasonal trends, market factors, or other external circumstances, which may affect all products.

In one embodiment, in response to a product being associated with a completed performance activity 1022 (such as a pre-determined performance threshold), the incentive module 1016 may suggest an appropriate increase in the market value of the particular product 1002. The incentive module 1016 may dynamically calculate this value based upon data concerning similar products across the digital platform 1010. In embodiments, the suggested market price can be the average market price for products that have accomplished the same or a similar performance activity within a given period.

The owner registration module 1030 may be configured to, in response to the target performance data for a given product meeting a target performance activity 1022 or threshold, send a notification 1070 to the owner of the product, send a notification 1070 to all owners of the plurality of products to which the given product belongs, instantly update all data points with respect to the product across the platform 1010 to signify completion of the target performance activity 1022 or threshold, or any combination thereof. The notification 1070 may include a link to access, view, or accept a given achievement identifier 1036 or one or more links to additional, dynamically selected performance data activities to further incentivize social interaction. In various exemplary embodiments, the UI can include the UI of a messaging application. The UI can display a notification such as any of the various notifications described herein. The notification can include a message of the messaging application. Such notification can be text providing an update regarding the market value of a given product or text providing notice of a new achievement identifier associated with a particular product. The notification can include a link that the owner or user can use to access or otherwise view the content related to the notification. The owner or a third-party user may view the notification 1070 on a computing device (e.g., computing device 1040(1) associated with owner 1008(1)), such as in the form of an email or SMS message. In embodiments, the owner or user may view the notification 1070 on the data platform 1010 via the owner or user's user interface.

The systems and methods may provide an incentive for further engaging in social interaction. In embodiments, such an incentive may be an opportunity to sell or purchase the physical article 1004, the digital identifier 1006, or both at a premium or a discount, as applicable. Once completed, the system may then track the effects of the user or owner's interaction with the digital platform 1010, the user or owner's degree of social interaction, or both as a result of the incentive over a period of time.

In one embodiment, the systems disclosed herein comprise a point of sale (POS) system 1060 that can include a cash register, a barcode scanner, a computing device, or other systems operable to facilitate sales transactions. A POS system 1060 may include or be in data communication with an inventory management system, a customer relationship management (CRM) system, a financial system, a warehousing system, or other systems. In some embodiments, the POS system 1060 does not include a physical POS system but may include a computing device or other type of device where a user can enter data to make a purchase.

In some embodiments, the data platform 1010 collects sales data regarding a particular transaction. This sales data can include data for a particular sales transaction, such as data indicating a product has sold, the quantity of products within a plurality of products 1002 that have been sold, the price at which a given product was sold, the time or date of the sale, the place of sale, the number of times a given product has been sold, or other sales data.

Certain embodiments can comprise a sales data module 1038 that can receive the sales data and store it in data storage 1050. In some embodiments, the sales data module 1038 may manipulate or aggregate the sales data in various ways. For instance, the sales data can be calculated for a desired time period for each product or each plurality of products, and that total sales data for the time period can be used to determine the perceived value of the given product or a plurality of products 1002.

In one embodiment, the digital platform 1010 may provision one or more user accounts on the digital platform 1010. A user account may include an account that stores information about a user (e.g., an owner 1008) and by which a user may view information regarding the user, another user, a specific product of the products 1002, or a combination thereof. In some embodiments, the digital platform 1010 may store user account data in the data storage 1050. The account module 1032 can allow a user of the digital platform 1010 to view, via a user interface (e.g., on the computing devices 1040), one or more achievement identifiers 1036 associated with a given product. The digital platform 1010 may permit this viewing such that a user may offer to purchase the product from the registered owner of the given product. In addition, the digital platform 1010 may allow a registered owner to offer the associated product for sale. The product can be offered for sale on the product selection module 1020 of the digital platform 1010.

In one embodiment, the UI includes a UI of a software application where a user can view his or her user account (e.g., a web browser). In one embodiment, the UI may include a list of products that are available for purchase via the product selection module 1020. The UI can provide a means for a user to view a list of products that are being offered for sale and whether a given product has any associated achievement identifiers 1036. The UI may include a list of products that are associated with a given achievement identifier. Under each product, the list may include a sale price or an opportunity to propose a price to purchase the given product. In some embodiments, the UI can display reports of products that have met a selected performance threshold or completed a specific performance activity 1022. The UI may include a UI element or achievement identifier 1036 indicating whether a current or prior owner of a particular product has completed a given performance activity 1022 or threshold. Such an achievement identifier 1036 can include text data (e.g., “Yes” or “No”), a checkbox, an emoji, a star, or some other UI element capable of indicating whether a given product is associated with a given performance activity or threshold. The UI may display the data based on account data stored in the data storage 1050. In some embodiments, the UI may include a progress bar associated with a given performance activity 1022 or threshold for a product (e.g., indicating the progress any past owner has made with respect to one or more performance activities or performance thresholds). The UI may include other data such as the date that a given product was sold or transferred, the date a particular performance activity 1022 or performance threshold was completed, or other data. In some embodiments, the UI may permit a user to “filter” certain products according to one or more categories. Exemplary categories include but are not limited to products from a specific vendor, manufacturer, artist, or other entity; products of a certain nature (clothing, accessories, household items, etc.); products that have achieved a given performance threshold or performance activity; products that are available for sale; products that are within a given price rage, or other product categories.

In embodiments, each data storage 1050 can be a database, a file system, or some other type of data storage. In some embodiments, one or more of the data storages 1050 can be located externally from the one or more computing devices that host the digital platform 1010. The external data storages 1050 can be in data communication with the platform 1010 via a data network.

In some embodiments, the data stored in the data storage 1050 includes metadata that may assist in classifying a given product or owners. The metadata may include data indicating the type of a given product, the sale price of a given product, the number of performance activities completed, the scarcity of the product, or the duration of time required to accomplish one or more performance activities with respect to a given product or group of products. The metadata may include other data.

In one embodiment, a communications module 1018 coordinates data communications between the digital platform 1010 and one or more computing devices. Within the digital platform 1010, the communications module 1018 can coordinate data communications between the various modules disclosed herein. The communications module 1018 may receive data from the one or more computing devices (which may include a personal device of a user or owner, such as computing device 1040(1) or computing device 1040(2), or a central computing device associated with the service provider). For example, the communications module 1018 may be configured to receive the performance activity data from the performance tracking module 1014 and send the performance activity data to the incentive module 1016. The communications module 1018 may store data in the data storage 1050. The data storage 1050 may be configured to store data and organize the data (e.g., by creating indices, generating metadata that makes the data searchable, etc.). The data storage 1050 can be configured to send a portion of the data to one or more modules of the digital platform 1010.

The communications module 1018 can be configured to receive or send any form of data that flows through the systems or is used in the methods described herein. For example, the communications module 1018 can be configured to transmit a notification to a computing device 1040 of a user or an owner 1008. In embodiments, the communications module 1018 receives a notification from the computing device 1040 of an owner or user. The communications module 1018 can be configured to coordinate all types of data communication regarding the digital platform 1010.

FIG. 2A and FIG. 2B are block diagrams illustrating embodiments of a system 100 of the present disclosure. The system 100 can include one or more memories 106. The memories 106 can store non-transitory computer-executable instructions 108. In one aspect, the system 100 disclosed herein includes a first computing device 102, which can be a server. The computing device 102 can comprise at least one processor 104. The non-transitory computer-executable instructions 108, upon execution, can cause the computing device 102 to transfer digital assets, incentivize social interaction via a digital platform, and/or perform one or more of the operations or methods described herein.

The system 100 can include a plurality of user computing devices. A first user computing device 110(1) associated with a first owner 120(1) and a second user computing device 110(2) associated with a second owner 120(1) are illustrated, however, more than two user computing devices can be included in the system 100, each user computing device associated with an owner of a product from among a plurality of products. Each user computing device 110 can comprise one or more input devices (such as a mouse or a keyboard), one or more output devices (including visual output devices (i.e., a screen), and one or more audio output devices (i.e., speakers, headphones, etc.)), or a combination thereof. The owner 120(1) may be the owner of a physical article 122(1) from among a plurality of physical articles 122 (e.g., products 1002). Each of the physical articles 122 can be associated with a digital identifier as described above. Further, the non-transitory computer-executable instructions 108 can be configured to, when executed by the computing device 102, cause the computing device 102 to offer or transfer ownership rights in one or more digital assets (i.e., the digital identifiers associated with the physical articles) to a user of the digital platform, a purchaser of the associated physical product, or a combination thereof. In some embodiments, the non-transitory computer-executable instructions 108 can be configured to, when executed by the computing device 102, cause the computing device 102 to record a transfer of the ownership rights in the digital asset (i.e., the digital identifier associated with the physical article) on the blockchain after a transfer of the digital asset. To do so, the computing device 102 may create a new block on the blockchain. The block may include data about the transaction such as the date and time, price, previous owner, new owner, an identification of the digital asset, achievement identifiers 128 associated with the digital asset, or other relevant information. The computing device 102 may record the transfer of the ownership rights in the digital asset directly or via a third-party NFT platform.

The non-transitory computer-executable instructions 108 may, when executed by the computing device 102, cause the computing device 102 to receive location data 112(1) from the user computing device 110(1) associated with owner 120(1) and location data 112(2) from the user computing device 110(2) associated with owner 120(2). The location of the of the owners 120(1) and 120(2) can be dynamically monitored by the computing device 102. In certain embodiments, an owner can enable a “tracking mode,” either on the physical article 122, the digital identifier associated with the physical article 122, the digital platform, a computing device 110 belonging to the owner, or a combination thereof. In some embodiments, each of the physical articles 122 comprises a means for tracking location data 112 of the physical article. Non-limiting, exemplary means for tracking location data include a satellite-based navigation or tracking system, a system that utilizes a cellular network, a system that utilizes Wi-Fi access points, a system that utilizes Bluetooth®, global positioning system (GPS), a system that employs short-range wireless tracking, or any combination of the foregoing. In specific embodiments, the means for tracking location data comprises radio frequency identification (RFID) tracking, assisted GPS (AGPS), a Wi-Fi positioning system, cell tower triangulation, Bluetooth® tracking, near-filed communication (NFC), a long range wide area network (LoRaWAN), IP geolocation, geofencing, a mobile network location application programming interface (API), or any combination thereof.

The computing device 102 can determine whether the location data 112(1) and the location data 112(2) are within a threshold geographical proximity 114 to one another. For example, the threshold geographical proximity 114 may be a distance between the owner 120(1) and the owner 120(2), a distance between the physical article 122(1) and the physical article 122(2), or a combination thereof. In embodiments, the threshold geographical proximity 114 can be less than 100 miles. The threshold geographical proximity 114 can be less than 500 miles. In embodiments, the threshold geographical proximity 114 is less than about 50 miles. The threshold geographical proximity 114 can be less than about 100 miles, about 90 miles, about 80 miles, about 70 miles, about 60 miles, about 50 miles, about 40 miles, about 30 miles, about 20 miles, or about 10 miles.

The non-transitory computer-executable instructions 108 may, when executed by the computing device 102, cause the computing device 102 to, in response to the location data 112(1) and the location data 112(2) being within the threshold geographical proximity 114 to one another, send a notification 116(1) to the user computing device 110(1) and a notification 116(2) to the user computing device 110(2) (collectively, notifications 116). The notifications 116 may include information that indicates the threshold geographical proximity 114 has been met based on the location data 112(1) and the location data 112(2).

In the example of FIG. 2B, the non-transitory computer-executable instructions 108 may, when executed by the computing device 102, cause the computing device 102 to determine whether the location data 112(1) and the location data 112(2) are within another threshold geographical proximity 124 to one another. Such an embodiment permits the two owners to dynamically monitor whether they are approaching one another or not approaching one another. For instance, the threshold geographical proximity 124 may be smaller than the threshold geographical proximity 116, which indicates that the locations are coming closer together (i.e., the distance between the owners is decreasing). In response to determining that the location data 112(1) and the location data 112(2) are within the threshold geographical proximity 124 to one another, the computing device 102 may send another notification 126(1) to the user computing device 110(1) and another notification 126(2) to the user computing device 110(2) (collectively, notifications 126). The notifications 126 may include information that indicates the owner 120(1) of the physical article 122(1) and the owner 120(2) of the physical article 122(2) are moving closer to one another. In response to determining that the location data 112(1) and the location data 112(2) are not within the threshold geographical proximity 124 and/or the threshold geographical proximity 114 to one another, the computing device 102 may send a notification to the user computing device 110(1) and a notification to the user computing device 110(2) which indicate that the owner 120(1) and the owner 120(2) are moving away from one another (i.e., the distance between the owners is increasing). For instance, the threshold geographical proximity 124 may be larger than the threshold geographical proximity 116, which indicates that the locations are moving away from each other.

The non-transitory computer-executable instructions 108 may, when executed by the computing device 102, cause the computing device 102 to determine that the location data 112(1) and the location data 112(2) substantially overlap for a predetermined time period 118. In embodiments, “substantially overlapping” means that the computing device 102 determines, based on the location data 112(1) and the location data 112(2), that the owner 120(1) and the owner 120(2) are within a distance of each other such that the owner 120(1) and the owner 120(2) can speak to one another. In other embodiments, “substantially overlapping” can indicate that the computing device 102 determines the owner 120(1) and the owner 120(2) are within a short distance from one another. In embodiments, “substantially overlapping” can indicate that the computing device 102 determines the owner 120(1) and the owner 120(2) are 30 feet or less from one another, 20 feet or less from one another, 10 feet or less from one another, 5 feet or less from one another, 3 feet or less from one another, or a combination thereof. A “given time period” can be a threshold of time to indicate that the owner 120(1) and the owner 120(2) have made a social connection. For example, the “given time period” can be the time taken for the owner 120(1), the owner 120(2), or both to have a social interaction (e.g., consume a meal, have a conversation, etc.). In embodiments, the “given time period” can be at least 1 minute, at least 2 minutes, at least 3 minutes, at least 4 minutes, at least 5 minutes, at least 6 minutes, at least 7 minutes, at least 8 minutes, at least 9 minutes, or at least 10 minutes. The “given time period” can be greater than 5 minutes, greater than 10 minutes, greater than 15 minutes, greater than 20 minutes, greater than 25 minutes, greater than 30 minutes, greater than 35 minutes, greater than 40 minutes, greater than 45 minutes, greater than 50 minutes, greater than 55 minutes or greater than 1 hour. In some embodiments, the non-transitory computer-executable instructions 108 may, when executed by the computing device 102, cause the computing device 102 to record the interaction from the user computing devices 110. For example, the computing device 102 can record the completion of a performance activity associated with a given digital asset in its memory 106.

In response to determining that the location data 112(1) and the location data 112(2) substantially overlap for the predetermined time period 118, the non-transitory computer-executable instructions 108 may, when executed by the computing device 102, cause the computing device 102 to display an achievement identifier 128(1) on a user interface 130(1) of the user computing device 110(1) and an achievement identifier 128(2) on a user interface 130(2) of the user computing device 110(2).

The UI can be used to transmit information or data to a user, receive instructions from a user (e.g., an owner 120), or a combination thereof. For example, when executed by the computing device 102, the non-transitory computer-executable instructions 108 can cause one of the digital assets to be displayed on one or more user computers 110 via their respective graphical user interfaces 130. As another example, when executed by the computing device 102, the non-transitory computer-executable instructions 108 may allow a user (e.g., an owner 120) to interact with the digital asset via their corresponding user computer 110. In one embodiment, when executed by the computing device 102, the non-transitory computer-executable instructions 108 can display an option on the user computers 110 for an owner 120 to accept or otherwise make publicly available on the digital platform any of the achievement identifiers 128 described herein. In some embodiments, when executed by the computing device 102, the non-transitory computer-executable instructions 108 may cause information, metadata, or other features of the digital asset to be displayed via the user interfaces 130, play over an audio output device of a user computing device 110, or a combination thereof. For example, visual images or videos can be displayed via the user interfaces 130 and the audio data can be transmitted to a user via the audio output device of the user computers 110. The non-transitory computer-executable instructions 108 may, when executed by the computing device 102, cause buttons or icons to be displayed on the user interfaces 130 that, when clicked on or hovered over (such as via a computer mouse), may cause the respective user computing device 110 to perform an additional operation. In embodiments, a subset of features may only be available following completion of one or more performance activities as described herein. For example, in some embodiments, the feature is available to an owner of a product after the owner has successfully made a social connection with an owner of a parallel product. Such a “feature” can include access to a new achievement identifier. In embodiments wherein a complete graphical design or attribute is distributed across each digital asset within a plurality of products, the feature can be an opportunity to “merge” or “import” the first owner's digital asset with the second owner's digital asset, or vice versa, to perceive a more complete representation of complete design or attribute.

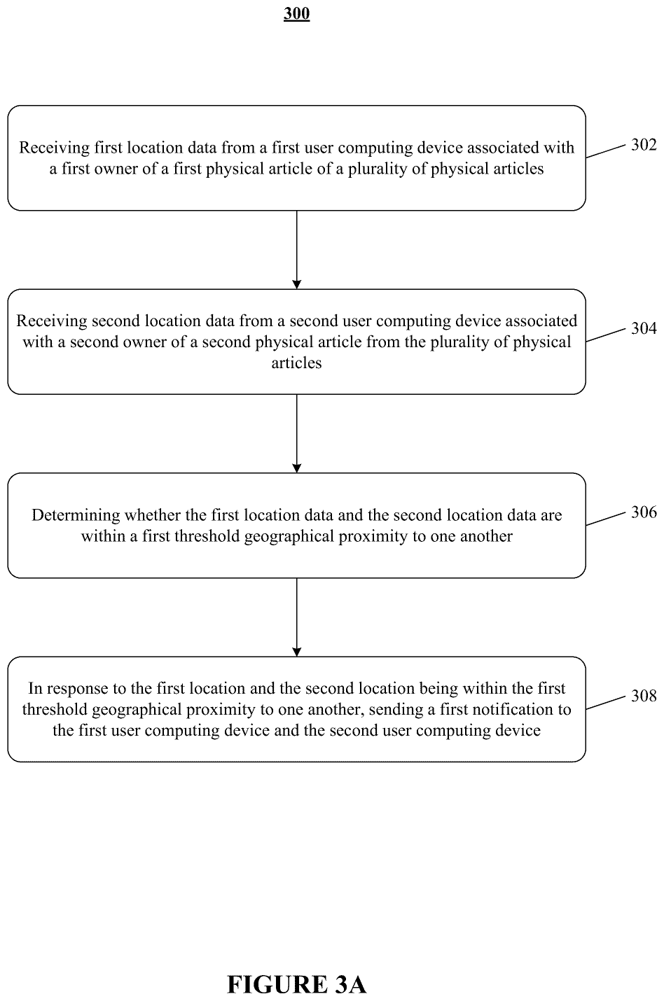

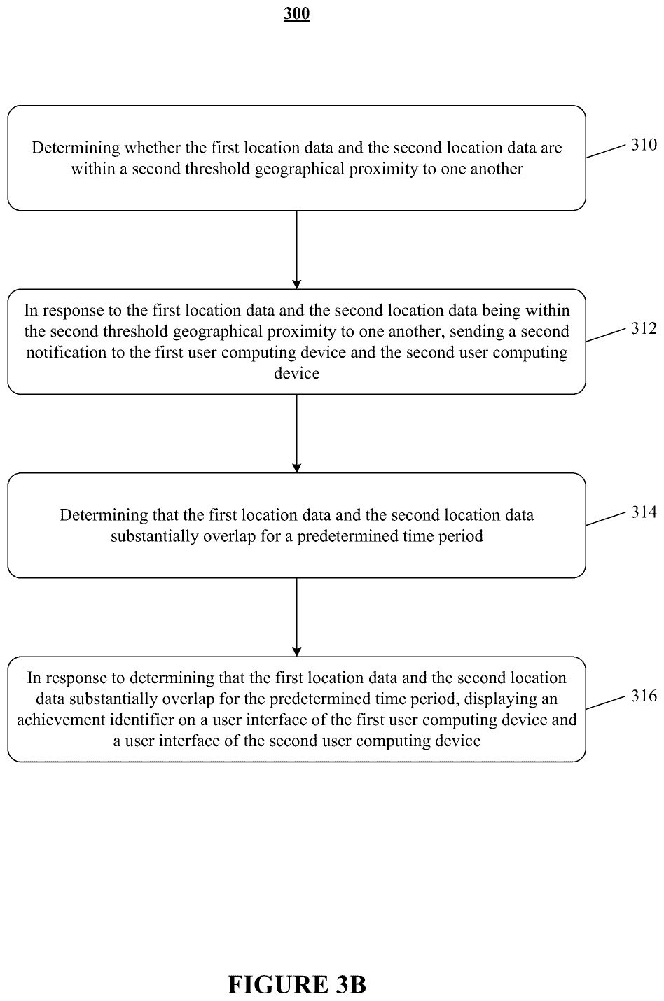

FIG. 3A is a flowchart diagram depicting one embodiment of a method 300 of the present disclosure. In certain embodiments, the method 300 may include the step of providing one or more memories 106. The memories 106 may store non-transitory computer-executable instructions 108 that utilize location data to determine whether a performance activity has been accomplished by at least two owners of physical articles. The method 300 may include the step of providing a computing device 102 with at least one processor 104 for executing the non-transitory computer-executable instructions 108.

The method 300 may include the step of providing a first user computing device 110(1) associated with a first owner 120(1) of a first physical article 122(1) of a plurality of physical articles. The method 300 may include the step of providing a second user computing device 110(2) associated with a second owner 120(2) of a second physical article 122(2) from the plurality of physical articles. In some embodiments, the physical articles comprise an article of clothing (e.g., a shirt, a jacket, a sweater, a sweatshirt, a hoodie, a pullover, shorts, pants, a skirt, a dress, a hat, a cap, a toboggan, a beanie, one or more shoes, one or more socks, an undergarment, or a combination thereof) or an accessory, wherein the accessory is capable of being worn by an owner of the physical article.

In some embodiments, the method 300 may include the steps of providing a plurality of products 1002 comprising a first product 1002(1) and a second product 1002(2), wherein each product comprises a physical article 1004 and an associated digital identifier 1006, and providing a digital platform 1010. The digital platform 1010 may include various modules, including but not limited to, a user interface 1012 configured to permit a user of the digital platform 1010 to perceive and interact with the digital platform 1010, a performance tracking module 1014 configured to track whether a performance activity 1022 has been completed, wherein the performance activity 1022 comprises a social connection between a first owner 1008(1) of the first product 1002(1) and a second owner 1008(2) of the second product 1002(2) (and configured in some embodiments to track the physical article, the digital identifier, the digital platform, a computing device belonging to the owner, or a combination thereof), an incentive module 1016 configured to reward the first owner 1008(1) and the second owner 1008(2) for completing the performance activity 1022, a communication module 1018 configured to receive performance activity data from the performance tracking module 1014 and send the performance activity data to the incentive module 1016, and a product selection module 1020 configured to permit a user to purchase a product from among the plurality of products 1002. In some embodiments, the digital identifier 1006 (e.g., an Internet Protocol (IP) address, a Medica Access Control (MAC) address, and electronic serial number, a Universally Unique Identifier (UUID), a Globally Unique Identifier (GUID), a barcode, a radio frequency identification (RFID), a QR code, a digital asset, a non-fungible token (NFT), or any combination thereof) comprises a means or mechanism used to distinguish and identify one or more individual and unique objects or a given plurality of objects.

The method 300 may include the step of executing, by the computing device 102, the non-transitory computer-executable instructions 108 to perform operations. The method 300 may include operation 302 of receiving first location data 112(1) from a first user computing device 110(1) associated with a first owner 120(1) of a first physical article 122(1) of a plurality of physical articles 122.

The method 300 may include operation 304 of receiving second location data 112(2) from a second user computing device 110(2) associated with a second owner 120(2) of a second physical article 122(2) from the plurality of physical articles 122.

The method 300 may include operation 306 of determining whether the first location data 112(1) and the second location data 112(2) are within a first threshold geographical proximity 114 to one another. In some embodiments, the first threshold geographical proximity 114 comprises a distance between the first owner 120(1) and the second owner 120(2), a distance between the first physical article 122(1) and the second physical article 122(2), or a combination thereof.

The method 300 may include operation 308 of, in response to the first location data 112(1) and the second location data 112(2) being within the first threshold geographical proximity 114 to one another, sending a first notification 116(1) to the first user computing device 110(1) and a first notification 116(2) to the second user computing device 110(2). In some embodiments, the first notification 116(1) and the first notification 116(2) indicate that the first threshold geographical proximity 114 has been met based on the first location data 112(1) and the second location data 112(2).

FIG. 3B is a continuation of the flowchart diagram illustrated in FIG. 3A. Briefly, following the events of FIG. 3A, the method 300 may include operation 310 of determining whether the first location data 112(1) and the second location data 112(2) are within a second threshold geographical proximity 124 to one another. The second threshold geographical proximity 124 may be smaller than the first threshold geographical proximity 114.

The method 300 may include operation 312 of, in response to the first location data 112(1) and the second location data 112(2) being within the second threshold geographical proximity 124 to one another, sending a second notification 126(1) to the first user computing device 110(1) and a second notification 126(2) the second user computing device 110(2). The second notification 126(1) and the second notification 126(2) may indicate that the first owner 120(1) and the second owner 120(2) are moving closer to one another. In some embodiments, the method 300 may further include an operation of, in response to the first location data 112(1) and the second location data 112(2) not being within the second threshold geographical proximity 124 to one another, sending a second notification 126(1) to the first user computing device 110(2) and a second notification 126(2) to the second user computing device 110(2), wherein the second threshold geographical proximity 124 is larger than the first geographical proximity 114 and the second notifications 126 indicate that the first owner 120(1) and the second owner 120(2) are moving away from one another.

The method 300 may include operation 314 of determining that the first location data 112(1) and the second location data 112(2) substantially overlap for a predetermined time period 118. In some embodiments, the operation 314 of determining that the first location data 112(1) and the second location data 112(2) substantially overlap for the predetermined time period 118 may include determining, based on the first location data 112(1) and the second location data 112(2), that the first owner 120(1) and the second owner 120(2) are within a distance of each other such that the first owner 120(1) and the second owner 120(2) can speak to one another.

The method 300 may include operation 316 of, in response to determining that the first location data 112(1) and the second location data 112(2) substantially overlap for the predetermined time period 118, displaying an achievement identifier 128(1) on a user interface 130(1) of the first user computing device 110(1) and an achievement identifier 128(2) on a user interface 130(2) of the second user computing device 110(2).

In some embodiments, the method 300 may further include an operation of determining that the first location data 112(1) and the second location data 112(2) are not within the first threshold geographical proximity 114 and the second threshold geographical proximity 124, and in response to determining that the first location data 112(1) and the second location data 112(2) are not within the first threshold geographical proximity 114 and the second threshold geographical proximity 124, sending a third notification to the first user computing device 110(1) and the second user computing device 110(2), the third notifications indicating that the first owner 120(1) and the second owner 120(2) are moving away from one another.

In some embodiments, the method may include one or more other actions or steps carried out by one or more elements of the systems that have been discussed previously. In some embodiments, one or more modules of the digital platform 1010 carry out one or more steps of the method.

In various embodiments, the methods disclosed herein may include a computer-implemented method for dynamically providing content or incentivizing social interaction. The method can include a computer-implemented method for dynamically providing other activities, trade, incentives, or other content. The method can include receiving performance data regarding a plurality of products 1002. The performance data may include the completion of certain performance activities associated with a given product, a plurality of products, or a group of products. By way of example, the performance activity 1022 can include whether two owners of products within a plurality of products 1002 have made a social connection, the duration of time required for the owners to make the social connection, or a combination thereof. The method can include dynamically calculating a threshold based on the performance data. The method can include determining, from the performance data associated with a product within a grouping of products, whether the performance data for the product is above the calculated threshold. The method can include, in response to the performance data for the given product being above the performance threshold, selecting an achievement identifier 128 for the product. The method may include sending a notification to the owner of the product. The notification can include a link to access suggested content.

The method may also include the step of providing a computing device for executing the non-transitory computer-executable instructions. The method may further include the step of evaluating whether a performance activity has been accomplished with respect to one or more digital assets. The method can include providing or suggesting a market value based upon the performance activity associated with a digital asset. The digital asset can be a non-fungible token (NFT).

The method may include the step of providing ownership rights in one or more digital assets to a user or owner. In embodiments, the ownership rights in one or more digital assets can be transferred to an owner via a smart contract. The method may further include the steps of assessing one or more performance activities with respect to the digital asset. The method may also include the step of recording a transfer of the ownership rights in the digital asset on the blockchain after such transfer of the digital asset.

In some implementations, the method may include the steps of providing a second computer, such as a user computing device, wherein the second computer is an owner's computer or a computer through which a user accesses the digital platform 1010 disclosed herein. Such a method can comprise providing a web-based portal accessible by the user's computer and displaying a graphical user interface on the user's computer display. The step of transferring ownership rights in the digital asset via a smart contract can be performed through the web-based portal.

In some implementations, the method may include the steps of providing a third computer, such as a user computing device, which can be another owner's computer. In such implementations, the method may include the steps of receiving a request to purchase a physical article, a digital asset (such as audio data, visual data, or audiovisual data), or a combination thereof and, processing the purchase via any of the POS systems described herein.

### Computer Hardware and Software

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer-readable media.

A blockchain, as used herein, can refer to a peer-to-peer, electronic ledger which is implemented as a computer-based decentralized, distributed computer-implemented system made up of blocks which, in turn, are made up of transactions. Each transaction is a data structure that encodes the transfer of control of a digital identifier between participants in the blockchain computer-implemented system and includes at least one input and at least one output. Each block contains a hash of the previous block so that blocks become chained together to create a permanent, unalterable record of all transactions which have been recorded to the blockchain since its inception. Transactions contain small programs, known as scripts, embedded into their inputs and outputs, which specify how and by whom the outputs of the transactions can be accessed.

For a transaction to be recorded to the blockchain, it must be “validated.” Network nodes (miners) perform work to ensure that each transaction is valid, with invalid transactions rejected from the network. Software clients installed on the nodes perform this validation work on an unspent transaction by executing its locking and unlocking scripts. If execution of the locking and unlocking scripts evaluates to TRUE, the transaction is valid and the transaction is recorded to the blockchain. Thus, for a transaction to be recorded to the blockchain, it should be (i) validated by the first node that receives the transaction—if the transaction is validated, the node relays it to the other nodes in the network; and (ii) added to a new block built by a miner; and (iii) mined, i.e., added to the public ledger of past transactions.

Blockchain can be used for the implementation of “smart contracts.” These are computer programs designed to automate the execution of the terms of a machine-readable contract or agreement. Unlike a traditional contract which would be written in natural language, a smart contract is a machine executable program that comprises rules that can process inputs to produce results, which can then cause actions to be performed dependent upon those results. In respect of commercial transactions, for example, these may involve the transfer of property rights and/or assets. Such assets may include real property, personal property (including both tangible and intangible property), digital assets, or any other type of asset. In the digital economy, there is often an expectation that exchanges and transfers will be performed in a timely manner and across vast distances. This expectation, along with practical and technical limitations, means that traditional forms of asset transfer, such as physical delivery of hardcopy of documents representing a contract, negotiable instrument, etc., or the tangible asset itself, is not desirable. Thus, smart contracts can provide enhanced control, efficiency, and speed of transfer in the digital economy.

One type of digital asset that can be transferred via a blockchain is a “token.” Tokens represent and transfer assets via the blockchain. A token serves as an identifier that allows the real-world or digital asset to be referenced from the blockchain. Similar to physical assets, the tokens that represent them may have many properties, one of which is fungibility or non-fungibility. Fungibility refers to the equivalence or interchangeability of each unit of a commodity with other units of the same commodity. Fungible tokens (FTs) are tokens that can be exchanged for any other token with the same value.

Fungible tokens (FTs) are uniform, that is, FTs of the same type are identical in specification, and each FT is identical to another FT of the same type. FTs are divisible into smaller amounts. In other words, users can own or transfer a fraction of an FT. Non-fungible tokens (NFTs), however, cannot be replaced with other tokens of the same type. NFTs represent nonfungible assets. Nonfungible assets have unique information or attributes. Each NFT is unique and differs from other tokens of the same class. In contrast to FTs, NFTs cannot be divided as the elementary unit of the NFT is the token itself.

In some embodiments, the creation of a digital asset stored on a blockchain can be performed via a third-party NFT platform. In such embodiments, the computing device can be communicably connected with the third-party platform, for example, via the internet. The non-transitory computer-executable instructions of such an embodiment can be configured to, when executed by the computing device, cause the computing device to transmit instructions to and receive data from the third-party platform. In other embodiments, the conversion of the input data into a digital asset stored on a blockchain can be done directly by the systems without the need for a third-party platform.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods, and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present disclosure of new and useful systems and methods dynamically providing content, it is not intended that such references be construed as limitations upon the scope of this disclosure.

The described systems and methods can be performed by a system that includes a single computer or more than one computer. A computer can be a processor-controlled device, such as, by way of example, personal computers, workstations, servers, clients, mini-computers, mainframe computers, laptop computers, smartphones, tablets, a network of one or more individual computers, mobile computers, portable computers, handheld computers, palmtop computers, set-top boxes for a TV, interactive televisions, interactive kiosks, personal digital assistants, interactive wireless devices, or any combination thereof.

A computer can be a uniprocessor or multiprocessor machine. Accordingly, a computer may include one or more processors and, thus, the aforementioned system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), gated logic, and other suitable hardware configured to perform the various functionality described throughout this disclosure.

The computer program or the computing device may include one or more memories. Such a memory can include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes a portable computer diskette, a random access memory (“RAM”), a read-only memory (“ROM”), an erasable programmable read-only memory (“EPROM” or Flash memory), a static random access memory (“SRAM”), dynamic random access memory (DRAM), electronically erasable programmable read-only memory (EEPROM), programmable read-only memory (PROM), erasable programmable read-only memory (EPROM), a hard disk drive (“HDD”), a solid state drive, a portable compact disc read-only memory (“CD-ROM”), a digital versatile disk (“DVD”), a memory stick, a floppy disk, videotapes, audio tapes, magnetic recording tracks, magnetic tunnel junction (MTJ) memory, optical memory storage, quantum mechanical storage, electronic networks, any mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In particular, the one or more memories may store computer-executable instructions that, when executed by the one or more processors, cause the one or more processors to implement the procedures and techniques described herein. The one or more processors can be operably associated with the one or more memories so that the computer-executable instructions can be provided to the one or more processors for execution. For example, the one or more processors can be operably associated to the one or more memories through one or more buses. Furthermore, the computer may possess or can be operably associated with input devices (e.g., a keyboard, a keypad, controller, a mouse, a microphone, a touch screen, a sensor) and output devices such as (e.g., a computer screen, printer, or a speaker).

The computer may execute an appropriate operating system such as LINUX®, UNIX®, MICROSOFT® WINDOWS®, APPLE® MACOS®, IBM® OS/2®, ANDROID, and PALM® OS, and/or the like. The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator can be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices can be used with programs constructed in accordance with some of the teachings described herein. In some embodiments, very specific computing machines, with specific functionality, can be required. Similarly, it may prove advantageous to construct a specialized apparatus to perform the method steps described herein by way of dedicated systems with hard-wired logic or programs stored in nonvolatile memory, such as, by way of example, read-only memory (ROM).

In some embodiments, features of the systems can be implemented primarily in hardware using, for example, hardware components such as application-specific integrated circuits (ASICs) or field-programmable gated arrays (FPGAs). Implementation of the hardware circuitry will be apparent to persons skilled in the relevant art(s). In yet another embodiment, features of the systems can be implemented using a combination of both general-purpose hardware and software.

In some embodiments, the systems and methods herein are used to transfer or modify digital assets. A digital asset, as referenced herein, can be any information that can be stored, transmitted, interpreted, and used that is encoded in a numeric format, including but not limited to information encoded as binary data. Generally, digital assets are stored in binary format, but other non-binary forms of encoding and storage can be known or developed for creating digital assets. Examples of digital assets include but are not limited to digital documents, audio, video, text, executable code in various formats, and any other type of information. Digital assets are not limited by the means of storage or transport, which can be electronic, optical, or other types of storage or transport mechanism existing or to be developed in the future.

Computer-readable program instructions described herein can be downloaded to respective computing/processing devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

In embodiments, the audio data comprises an audio file that contains non-transitory computer-executable instructions that, when executed by a computer, cause the computer to play audio through an audio output device, such as a speakers or headphones. Audio files may contain (optionally only contain) non-transitory computer-executable instructions for playing audio from part of a complete song or track. For example, an audio file may only contain audio from a single instrument, such as vocals, guitar, keys, bass, or drums. An audio stem may also contain audio data from one portion of a track, such as the melody, harmony, rhythm, etc.

The visual data can include still visual images or videos. The visual data can comprise video or image files containing non-transitory computer-executable instructions that encode for various visual images, components of images, videos, or components of videos that were created by a user. Audiovisual data can include data that is a combination of visual data and audio data, which is synchronized to provide a single, cohesive viewing experience by a user. In some embodiments, the systems can comprise a memory having non-transitory computer-executable instructions configured to, when executed by the computing device, cause the computing device to generate a visual image or video using visual data. In some embodiments, the computing device may generate a plurality of visual images or videos using the visual data.

The non-transitory computer-executable instructions can be configured to, when executed by the computing device, cause the computing device to convert certain data (such as audio data, visual data, or audiovisual data created by a user) into data stored on the digital platform.

In some embodiments, the systems can comprise one or more user computers. Each user computer can comprise input devices (such as a mouse or a keyboard), output devices (including visual output devices (i.e., a screen) and audio output devices (i.e., speakers, headphones, etc.)), or a combination thereof. The non-transitory computer-executable instructions can be configured to, when executed by the computing device, cause the computing device to provide a web-based portal accessible by the one or more user computers. The web-based portal can be configured to display a graphical user interface on the one or more user computers to access the digital platform.

Exemplary methods of secure communication can be used between two or more computers of the systems. Different embodiments of these exemplary methods can be implemented depending on the particular implementation details of the systems. Furthermore, the order in which the steps of the method are presented is not intended to imply a required sequence for the steps. Rather, the steps can be implemented in a different sequence and/or some or all of the steps can be implemented simultaneously.

### EQUIVALENTS

The presently disclosed systems and methods have a wide application anywhere in the computer industry where the transfer or revision of digital assets in association with completion of a performance activity is needed. One particularly important application for the systems and methods described herein relates to creation and transfer of digital assets on digital platforms to incentive social interaction between owners of parallel products. However, the systems and methods described above could be utilized in other contexts.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

What is claimed is:

1. A system, comprising:
a plurality of products comprising a first product and a second product, wherein each product comprises a physical article and an associated digital identifier;
a digital platform, comprising:
a user interface configured to permit a user of the digital platform to perceive and interact with the digital platform;
a performance tracking module configured to track whether a performance activity has been completed, wherein the performance activity comprises a social connection between a first owner of the first product and a second owner of the second product;
an incentive module configured to reward the first owner and the second owner for completing the performance activity; and
a communications module configured to receive performance activity data from the performance tracking module and send the performance activity data to the incentive module.

2. The system of claim 1, wherein the physical article comprises an article of clothing or an accessory, wherein the accessory is capable of being worn by an owner of the physical article.

3. The system of claim 2, wherein the article of clothing comprises a shirt, a jacket, a sweater, a sweatshirt, a hoodie, a pullover, shorts, pants, a skirt, a dress, a hat, a cap, a toboggan, a beanie, one or more shoes, one or more socks, an undergarment, or a combination thereof.

4. The system of claim 1, wherein the digital identifier comprises a means or mechanism used to distinguish and identify one or more individual and unique objects or a given plurality of objects.

5. The system of claim 4, wherein the digital identifier comprises an Internet Protocol (IP) address, a Medica Access Control (MAC) address, and electronic serial number, a Universally Unique Identifier (UUID), a Globally Unique Identifier (GUID), a barcode, a radio frequency identification (RFID), a QR code, a digital asset, a non-fungible token (NFT), or any combination thereof.

6. The system of claim 1, further comprising a product selection module configured to permit a user to purchase a product from among the plurality of products.

7. The system of claim 1, wherein the performance tracking module is further configured to track the physical article, the digital identifier, the digital platform, a computing device belonging to the owner, or a combination thereof.

8. A computer-implemented method, comprising:
receiving, by a computing device, first location data from a first user computing device associated with a first owner of a first physical article of a plurality of physical articles;
receiving, by the computing device, second location data from a second user computing device associated with a second owner of a second physical article from the plurality of physical articles;
determining, by the computing device, whether the first location data and the second location data are within a first threshold geographical proximity to one another; and
in response to the first location data and the second location data being within the first threshold geographical proximity to one another, sending, by the computing device, a first notification to the first user computing device and the second user computing device.

9. The computer-implemented method of claim 8, further comprising:
determining, by the computing device, whether the first location data and the second location data are within a second threshold geographical proximity to one another;
in response to the first location data and the second location data being within the second threshold geographical proximity to one another, sending, by the computing device, a second notification to the first user computing device and the second user computing device;
determining, by the computing device, that the first location data and the second location data substantially overlap for a predetermined time period; and
in response to determining that the first location data and the second location data substantially overlap for the predetermined time period, displaying, by the computing device, an achievement identifier on a user interface of the first user computing device and a user interface of the second user computing device.

10. The computer-implemented method of claim 9, wherein determining that the first location data and the second location data substantially overlap for the predetermined time period comprises determining, based on the first location data and the second location data, that the first owner and the second owner are within a distance of each other such that the first owner and the second owner can speak to one another.

11. The computer-implemented method of claim 9, wherein the second threshold geographical proximity is smaller than the first threshold geographical proximity.

12. The computer-implemented method of claim 9, wherein the second notification indicates that the first owner and the second owner are moving closer to one another.

13. The computer-implemented method of claim 9, further comprising:
determining that the first location data and the second location data are not within the first threshold geographical proximity and the second threshold geographical proximity; and
in response to determining that the first location data and the second location data are not within the first threshold geographical proximity and the second threshold geographical proximity, sending, by the computing device, a third notification to the first user computing device and the second user computing device.

14. The computer-implemented method of claim 13, wherein the third notification indicates that the first owner and the second owner are moving away from one another.

15. The computer-implemented method of claim 8, further comprising:
determining, by the computing device, whether the first location data and the second location data are within a second threshold geographical proximity to one another;
in response to the first location data and the second location data not being within the second threshold geographical proximity to one another, sending, by the computing device, a second notification to the first user computing device and the second user computing device.

16. The computer-implemented method of claim 15, wherein the second threshold geographical proximity is larger than the first threshold geographical proximity.

17. The computer-implemented method of claim 15, wherein the second notification indicates that the first owner and the second owner are moving away from one another.

18. The computer-implemented method of claim 8, wherein the first threshold geographical proximity comprises a distance between the first owner and the second owner, a distance between the first physical article and the second physical article, or a combination thereof.

19. The computer-implemented method of claim 8, wherein the first notification indicates that the first threshold geographical proximity has been met based on the first location data and the second location data.

20. A system, comprising:
at least one memory storing non-transitory computer-executable instructions;
a computing device with at least one processor for executing the non-transitory computer-executable instructions;
a first user computing device associated with a first owner of a first physical article of a plurality of physical articles; and
a second user computing device associated with a second owner of a second physical article from the plurality of physical articles;
wherein, when executed by the computing device, the non-transitory computer-executable instructions cause the computing device to perform operations comprising:
receiving first location data from the first user computing device;
receiving second location data from the second user computing device;
determining whether the first location data and the second location data are within a first threshold geographical proximity to one another; and
in response to the first location data and the second location data being within the first threshold geographical proximity to one another, sending a first notification to the first user computing device and the second user computing device.
